(19) United States
(12) Patent Application Publication
(10) Pub. No.: US 2008/0261056 A1
(43) Pub. Date: Oct. 23, 2008

(54) Photocatalytic Substrate Active Under a Visible Light

(75) Inventors: Laurent Labrousse, Saint Prim (FR); Lethicia Gueneau, Vincennes (FR); Andriy Kharchenko, Palaiseau (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 11/578,035

(22) PCT Filed: Apr. 12, 2005
(86) PCT No.: PCT/FR2005/050229

§ 371 Date: Aug. 20, 2007

(30) Foreign Application Priority Data
Apr. 13, 2004 (FR) 0403824

(51) Int. Cl. B32B 9/04; C09D 1/00; B32B 9/00

(52) U.S. Cl. 428/447; 106/286.4; 106/286.2; 106/286.3; 106/286.6; 106/286.1; 428/702; 428/469; 427/226

(57) ABSTRACT

The invention relates to a substrate provided with a mechanically resistant, long-lasting coating, and suitable for being handled by a user. Said substrate is characterised in that the coating comprises a first photocatalytic compound which is intimately associated with a second compound containing an energy jump between the upper level of the valence band thereof and the lower level of the conductive band thereof, corresponding to a wavelength in the visible field. The invention also relates to a glazing comprising said substrate, to the applications of the inventive substrate, and to the methods for the production thereof.

The present invention relates to self-cleaning substrates, which clean by the photocatalytic activity of appropriate constituent agents.

Thus, EP 850 204 discloses a coating comprising titanium dioxide crystallized in anatase and/or rutile form, which, in sufficient concentration or thickness, has the particular feature of forming free radicals under ultraviolet radiation, and consequently of initiating the radical oxidation of any oily, fatty or hydrocarbon deposit.

This coating is also hydrophilic under ultraviolet radiation. Fatty soiling is therefore degraded into shorter molecules under the action of sunlight, and then rainwater is spread as a uniform film, guaranteeing the best possible homogenization of the degradation products and any mineral dust. Traces remaining after this film has been removed are thus considerably reduced, or even eliminated. Such substrates, when in a vertical or inclined position, may be termed “self-cleaning”.

TiO₂ crystallized in anatase form also has a weak photocatalytic activity in the more energetic portion of the visible spectrum, and therefore it is desired to increase this activity and to shift it toward longer wavelengths, with a view to use in the absence or virtual absence of ultraviolet radiation, especially inside buildings, passenger compartments or cabins of transport vehicles, etc. This is because glazing lets through especially the visible portion of sunlight, but not ultraviolet rays.

Moreover, photocatalytic activity under visible illumination is also of great benefit outdoors, the energy of the solar spectrum being greater in the visible than in the ultraviolet.

In this regard, US 2003/144140 discloses the way of controlling the recombination of electron-hole pairs at the junction of a compound that is photocatalytic under ultraviolet radiation, such as TiO₂, and of a mixed oxide, such as Ce₂Zr₂O₈, which is photocatalytic under visible light. However, this document deals exclusively with powder preparation techniques, without indicating any possibility of extrapolation to a film coating.

US 2003/232186 also discloses the powder blending of a photocatalytic compound that is active under ultraviolet radiation with a photocatalytic compound that is active in the visible. The latter compound consists of rutile and/or anatase TiO₂, certain atoms of which are substituted with nitrogen atoms. The formation of coatings as films using this principle is not disclosed.

WO 02/92879 discloses a thin-film coating on a substrate, especially a glass substrate, consisting of anatase TiO₂ particles whose photocatalytic activity under ultraviolet radiation is enhanced by the fact that these particles are in a binder comprising a semiconducting metal oxide, such as SnO₂:F. There is no mention of photocatalytic activity under excitation by visible light.

The object of the present invention is therefore to provide a material exhibiting exploitable antisoiling and/or hydrophilic activity when it receives only visible light, and moreover capable of constituting a coating of high mechanical strength on various substrates which are substantially flat, fibrous, etc.

For this purpose, the subject of the invention is a substrate coated with a mechanically strong and durable film allowing handling by a user, characterized in that the film comprises, in intimate association, a photocatalytic first compound and a second compound having a bandgap, between the upper level of its valence band and the lower level of its conduction band, corresponding to a wavelength in the visible range.

The substrate of the invention is a glass, a ceramic, a glass-ceramic, a metal (steel, stainless steel), a building material (interior wall, possibly coated/rendered, etc.), a mineral material, wood, or a plastic. It may consist of a flat or curved surface, or of fibers combined in various known manners (fabric, etc.), such as glass fibers for thermal and acoustic insulation in a binder, or for reinforcement, natural fibers and synthetic fibers.

Within the context of the invention, said photocatalytic first compound generally has a minimum activation energy in a more energetic range than visible light—this is the case for ZrO₂, KTaO₃, Nb₂O₅ and SnO₂.

Although this minimum energy, in the case of TiO₂, is located in the most energetic portion of the visible spectrum, it should be pointed out that the photocatalytic activity of TiO₂ exclusively under visible light is very low, and much more important and usable for an antisoiling functionality, under ultraviolet radiation.

Nevertheless, titanium dioxide, in particular at least partly crystallized in anatase form, known for forming durable and abrasion-resistant coatings on transparent substrates for which high optical quality is required, is of course the core of the invention.

Specifically, by combining said well-chosen second compound, the photocatalytic activity of TiO₂ in the visible is increased and becomes usable.

Moreover, within the context of the invention, situations in which said photocatalytic first compound has a minimal activation energy in a range less energetic than visible light, such as for example Si, are not excluded.

As is known, the inherent capability of the photocatalytic compound to initiate radical oxidations results in particular from its characteristics regarding the lifetime of electron-hole pairs, a quantity of these pairs generated, and a diffusion of these pairs. However, insufficiency in some of these characteristics results in a weaker to almost zero antisoiling and/or hydrophilic functionality, which may justify excluding the compounds from certain applications requiring a high photocatalytic activity.

For its part, said second compound, taken in isolation, does generate electron-hole pairs under visible light, but the durability, quantity and diffusion characteristics of these pairs do not, in general, necessarily allow it to be termed a photocatalytic compound. However, when combined with said photocatalytic first compound, the inventors have established that it can be rendered photocatalytically active—or at the very least its photocatalytic activity could be increased—under visible light by displacement of the electrons and holes generated in said second compound, respectively, into the conduction band and the valence band, respectively, of the photocatalytic first compound.

Even if, in a first case, the bandgap between the upper level of the valence band and the lower level of the conduction band of the second compound is less than the excitation energy of the photocatalytic first compound required to obtain the maximum activity thereof, the photocatalytic first compound acquires an activity that it did not have, or had only little, under visible light.

In a second case, the bandgap between the upper level of the valence band and the lower level of the conduction band of the second compound is on the contrary equal to or higher than the excitation energy of the photocatalytic first compound required to obtain the maximum activity thereof, and the latter exhibits even greater photocatalytic activity under visible light.

Preferably, said bandgap of the second compound is between 1.55 eV and 3.26 eV.

Since the energy is known to be related to the wavelength by the equation:

E(in eV)=1240/λ(in nm),

the aforementioned values correspond to the extreme wavelengths of the visible spectrum, i.e. 800 nm and 380 nm.

The second compound may thus be chosen from GaP, CdS, KTa_{0.77}Nb_{0.23}O₃, CdSe, SrTiO₃, TiO₂, ZnO, Fe₂O₃, WO₃, Nb₂O₅, V₂O₅ and Eu₂O₃.

In a preferred embodiment, the substrate is transparent and its antisoiling/hydrophilic functionality is of a nature so as to maintain its high initial transparency and optical quality under exclusively visible light. Organic pollution is then degraded into smaller molecules less adherent and less fatty, and more easily able to be removed, especially by water in the form of a film owing to the hydrophilic property of the coating.

It may be envisaged combining a means of spraying more or less regularly.

In the absence of water, the degradation products of the organic soiling may be removed with a rag, as easily as mineral dust. A chemically active agent, such as a detergent, is superfluous.

The term “transparent substrate” is understood to mean especially a plastic such as polycarbonate, polymethyl methacrylate, polypropylene, polyurethane, polyvinyl butyral, polyethylene terephthalate, polybutylene terephthalate, an ionomer resin, such as a polyamine-neutralized ethylene/(meth)acrylic acid copolymer, a cycloolefin copolymer, such as an ethylene/norbornene or ethylene/cyclopentadiene copolymer, a polycarbonate/polyester copolymer, an ethylene/vinyl acetate copolymer and similar copolymers, by themselves or in blends.

According to an advantageous variant, the transparent substrate is made of glass, at least one surface part of which, oriented toward said coating, is dealkalized. This is because the alkalis contained in the glass migrate to the surface, in particular under the effect of heating, and affect the photocatalytic activity of the coating.

Dealkalization in at least one area of its surface oriented toward said coating means that the substrate does not contain alkali metal and alkaline-earth metal oxides in a total proportion exceeding 15% by weight, nor sodium oxide in a proportion exceeding 10% by weight.

Soda-lime-silica glass thus dealkalized is obtained by treatments employing various techniques, especially electrical treatments, such as corona discharge, as described in documents WO 94/07806-A1 and WO 94/07807-A1.

According to another advantageous variant, said coating has a (meso)porous structure, in particular in accordance with the teaching of WO 03/087002-A1. Such a structure is distinguished by a large contact surface area and a network of pores that communicate with one another, and finally by a particularly high photocatalytic activity. Thus, for a coating consisting only of TiO₂, a porosity of 70 to 90%, defined as the percentage of the theoretical density of TiO₂, which is about 3.8, is favorable.

To amplify the photocatalytic effect of the titanium oxide of the coating according to the invention, it is firstly possible to increase the absorption band of the coating by incorporating other particles into the coating, especially metal particles based on cadmium, tin, tungsten, zinc, cerium or zirconium.

It is also possible to increase the number of charge carriers by doping the crystal lattice of titanium oxide, by inserting at least one of the following metal elements thereinto: niobium, tantalum, iron, bismuth, cobalt, nickel, copper, ruthenium, cerium and molybdenum.

This doping may also be carried out by doping just the surface of titanium oxide or the entire coating, surface doping being carried out by covering at least one part of the coating with a layer of oxides or of metal salts, the metal being chosen from iron, copper, ruthenium, cerium, molybdenum, vanadium and bismuth.

Finally, the photocatalytic effect may be amplified by increasing the yield and/or rate of the photocatalytic reactions by covering the titanium oxide, or at least part of the coating which incorporates it, with a noble metal in the form of a thin film of the platinum, rhodium, silver or palladium type.

Such a catalyst, for example deposited by a vacuum technique, makes it possible in fact to increase the number and/or lifetime of the radical entities created by the titanium oxide, thus to favor chain reactions resulting in the degradation of organic substances.

The thickness of the coating according to the invention can vary—it is preferably between 2 nm and 1 μm, especially between 5 nm and 100 nm, and preferably not exceeding 80 nm. This thickness is adapted according to the envisioned application, since the photocatalytic activity increases with constant thickness. In addition, an increased thickness may be chosen in order to limit any alkali metals from an underlying glass into the depth of the coating and to prevent them from reaching the most surface active part.

The coating may be chosen to have a greater or lesser surface smoothness. However, a certain roughness may be advantageous:
it makes it possible to develop a larger photocatalytically active surface and therefore it results in a higher photocatalytic activity; and
it has a direct influence on wetting, since roughness enhances the wetting properties. A smooth hydrophilic surface will be even more hydrophilic once it has been roughened. The term “roughness” is understood here to mean both surface roughness and roughness induced by porosity of the film in at least one part of its thickness.

The above effects will be even more pronounced when the coating is porous and rough, hence a super-hydrophilic effect of rough photoreactive surfaces. However, if too pronounced, the roughness may be detrimental, by favoring incrustation and accumulation of soiling and/or by introducing an optically unacceptable level of haze.

It has thus proved to be beneficial to adapt the method of depositing coatings based on TiO₂ or other compounds so that they have a roughness of about 0.2 to 20 nm, this roughness being evaluated by atomic force microscopy, by measuring the RMS (root mean square) value on 1 micron square surface. With such roughness levels, the coatings have a hydrophilicity manifested by a water contact angle that may be less than 1°.

Between the substrate and the coating according to the invention may be placed one or more other films having an antistatic, thermal or optical function, or a function that favors crystal growth of TiO₂ in anatase or rutile form, in addition to films according to the invention acting as a barrier to the migration of certain elements coming from the substrate, especially a barrier to alkaline metal ions and most particularly sodium ions when the substrate is made of glass.

It is also possible to envisage an “anti-reflection” multilayer stack comprising an alternation of high-index and low-index thin films, the coating according to the invention constituting the final film of the stack. In this case, it is preferable for the coating to have a relatively low refractive index, which is the case when it consists of a mixed titanium and silicon oxide.

The film having an antistatic and/or thermal function (a heating function by providing it with current leads, a low-emissivity function, a solar protection function, etc.) may especially be chosen to be based on a conducting material of the metal type, such as silver, or of the doped metal oxide type, such as tin-doped indium oxide (ITO), tin oxide doped with a halogen of the fluorine type (SnO₂:F) or doped with antimone (SnO₂:Sb), or indium-doped zinc oxide (ZnO:In), fluorine-doped zinc oxide (ZnO:F), aluminum-doped zinc oxide (ZnO:Al) or tin-doped zinc oxide (ZnO:Sn). It may also be a metal oxide substoichiometric in oxygen, such as SnO₂₋ₓ or ZnO₂₋ₓ, where x<2.

The film having an antistatic function preferably has a surface resistance of 20 to 1000 ohms/□. It may be provided with current leads so as to bias it (for example with supply voltages between 5 and 100 V). This controlled biasing makes it possible in particular to combat the deposition of dust with a size of the order of one millimeter that is liable to be deposited on the coating, especially adherent dry dust that by electrostatic effect: by suddenly reversing the bias of the film, this dust is “ejected”.

The thin film having an optical function may be chosen so as to reduce the light reflection and/or make the color of the substrate in reflection more neutral. In this case, it preferably has an intermediate refractive index between that of the coating and that of the substrate and an appropriate optical thickness, and may consist of an oxide or a mixture of oxides of the aluminum oxide (Al₂O₃), tin oxide (SnO₂), indium oxide (In₂O₃) and silicon oxycarbide or oxynitride type. To obtain maximum attenuation of the color in reflection, it is preferable for this thin film to have a refractive index close to the square root of the product of the squares of the refractive indices of the two materials flanking it, that is to say the substrate and the coating according to the invention. At the same time, it is advantageous to choose its optical thickness (that is to say its geometric thickness multiplied by its refractive index) close to lambda/4, lambda being approximately the mean wavelength in the visible, especially about 500 to 500 nm.

Combining said second compound having a bandgap corresponding to a wavelength in the visible may give the coating a certain color, for example yellow. In this case, the thin film having an optical function is advantageously absorbent in the yellow.

The thin film having an alkali metal barrier function may be chosen especially to be based on a silicon oxide, nitride, oxynitride or oxycarbide, a fluorine-containing aluminum oxide (Al₂O₃:F) or aluminum nitride. This is because it has proved to be useful when the substrate is made of glass, since the migration of sodium ions into the coating according to the invention may, under certain conditions, impair the photocatalytic properties thereof.

The nature of the substrate or of the subfilm also has an additional benefit: it may promote the crystallization of the photocatalytic film that is deposited, especially in the case of CVD deposition.

Thus, during deposition of TiO₂ by CVD, a crystallized SnO₂:F subfilm promotes the growth of TiO₂ in predominantly rutile form, especially for deposition temperatures of around 400° to 500° C., while the surface of a soda-lime glass or of a silicon oxycarbide subfilm causes instead TiO₂ growth as anatase, especially for deposition temperatures of around 4000 to 600° C.

All these optional thin films may be deposited in a known manner by vacuum techniques of the sputtering type, especially magnetron sputtering, or by other techniques of the thermal decomposition type, such as pyrolysis in the solid, liquid or gas phase. Each of the aforementioned films may combine several functions, but it is also possible to superpose them.

Advantageously, the subfilm forming a barrier to the migration of alkaline metals is directly in contact with the glass, and is itself directly covered with the thin film having an optical function, which in turn is joined to the coating of the invention via the film having an antistatic and/or thermal function.

The subject of the invention is also:
antisoiling and/or hydrophilic (antifogging) glazing, whether monolithic, multiple (of the double-glazing type) or laminated glazing incorporating the substrate described above; and
the application of this substrate to the manufacture of hydrophilic and/or antisoiling, self-cleaning glazing, of the type for removing organic and/or mineral soiling, especially glazing for buildings, of the double-glazing type, vehicle glazing, of the automobile windshield, rear window or side window type, glazing for trains, aircraft and water-borne vehicles or utilitarian glazing, such as glass for aquaria, shop windows, greenhouses or porches, glass for interior furnishings, such as tables, shelves, staircase treads, walls in any position, said glass optionally having surface irregularities, especially being printed, textured, satined, sanded, lacquered or varnished, ophthalmic glass, glazing for urban furniture, mirrors, television, telephone or similar screens, glazing having electronically controlled variable absorption, covers for lamps, of the flat lamp or tunnel lamp type, or any architectural material, of the curtain wall, cladding or roofing type, such as tiles, rendering.

Other subjects of the invention consist of processes for obtaining the substrate described above, in which processes said coating is deposited:
either by liquid pyrolysis, especially from a solution comprising at least one precursor of said photocatalytic first compound, especially a titanium organometallic precursor of the titanium chelate and/or titanium alcoholate type, and a precursor of said second compound;
or by a sol-gel technique, with a deposition mode of the dip-coating, cell-coating, spray-coating or laminar flow-coating type, using a solution comprising at least said photocatalytic first compound and said second compound and/or a precursor of said photocatalytic first compound, especially a titanium organometallic precursor of the titanium alcoholate type, and a precursor of said second compound;
or by chemical vapour deposition (CVD) from at least one precursor of said photocatalytic first compound, especially a titanium precursor of the halogen or organometallic type, and a precursor of said second compound;
or by a reduced-pressure technique, such as reactive or nonreactive sputtering, especially magnetron sputtering.

### EXAMPLE

Soda-lime float glass plates measuring 30 cm×30 cm×2.2 mm were coated with a 150 nm-thick SiO₂ film.

Magnetron sputtering was carried out with the following characteristics:
pressure: 2 μbar;
gas: 15 sccm Ar/12 sccm O₂;
power: 2 kW;
Si/Al (8 wt %) target: 50 cm×15 cm.

30 cm×30 cm glass/150 nm SiO₂ specimens were cut into smaller ones measuring 10 cm×15 cm, which were coated with a 100 nm TiO₂ film by magnetron sputtering with the following characteristics:
pressure: 24 μbar;
gas: 47 sccm Ar/5 sccm O₂;
power 1 kW;
metal (99.96% Ti) target: 20 cm×9 cm

Instead of a TiO₂ film, a TiO₂ film containing various proportions of Nb₂O₅ was formed by bonding one or more Nb plates measuring 2 cm×1 cm×1 mm to the Ti metal target, all the conditions for carrying out the magnetron process being the same.

The photocatalytic activity of the various specimens under low residual UV radiation were evaluated.

Specimens measuring 2.5 cm×2.5 cm were cut.

A solution of 0.1 g of stearic acid in 10 ml of ethanol was prepared and stirred for 40 minutes.

The specimen was cleaned with UV radiation/ozone for 40 minutes.

60 μl of stearic acid solution was deposited on each specimen by spin coating.

The amount of stearic acid was measured by FTIR analysis initially, and then after two hours of illumination by a fluorescent lamp delivering essentially visible light (low residual UVA radiation of 1.4 W/m²).

The proportion of stearic acid degraded by the film was thus deduced therefrom.

The amount of degraded stearic acid measured was 15% for a pure TiO₂ film, while this amount reached a maximum of 18% for a percentage amount of Nb atoms divided by the sum of the Nb and Ti atoms of 2.6 at %.

This result shows the increased photocatalytic activity under visible light of TiO₂ by intimately combining it with Nb₂O₅.

1. A substrate with a mechanically strong and durable coating allowing handling by a user, characterized in that the coating comprises, in intimate association, a photocatalytic first compound and a second compound having a bandgap, between the upper level of its valence band and the lower level of its conduction band, corresponding to a wavelength in the visible range.

2. The substrate as claimed in claim 1, characterized in that said bandgap of the second compound is between 1.55 eV and 3.26 eV.

3. The substrate as claimed in claim 2, characterized in that said second compound is chosen from GaP, CdS, KTa_{0.77}Nb_{0.23}O₃, CdSe, SrTiO₃, TiO₂, ZnO, Fe₂O₃, WO₃, Nb₂O₅, V₂O₅ and Eu₂O₃.

4. The substrate as claimed in one of claims 1 to 3, characterized in that it is transparent and its antisoiling/hydrophilic functionality is of a nature so as to maintain its high initial transparency and optical quality exclusively under visible light.

5. The substrate as claimed in claim 4, characterized in that it is made of glass, at least one surface part of which, oriented toward said coating, is dealkalized.

6. The substrate as claimed in one of the preceding claims, characterized in that said coating has a mesoporous structure.

7. The substrate as claimed in one of the preceding claims, characterized in that particles, especially metal particles based on cadmium, tin, tungsten, zinc, cerium or zirconium, are incorporated into said coating.

8. The substrate as claimed in one of claims 1 to 6, characterized in that at least one of the metal elements chosen from niobium, tantalum, iron, bismuth, cobalt, nickel, copper, ruthenium, cerium and molybdenum is inserted into the crystal lattice of said photocatalytic first compound.

9. The substrate as claimed in one of claims 1 to 6, characterized in that at least one part of said coating is covered with a layer of oxides or of metal salts, the metal being chosen from iron, copper, ruthenium, cerium, molybdenum, vanadium and bismuth.

10. The substrate as claimed in one of claims 1 to 6, characterized in that said photocatalytic first compound, or at least one part of said coating, is covered with a noble metal in the form of a thin film of the platinum, rhodium, silver or palladium type.

11. The substrate as claimed in one of the preceding claims, characterized in that the thickness of said coating is between 2 nm and 1 μm, especially between 5 nm and 100 nm, and preferably not exceeding 80 nm.

12. The substrate as claimed in one of the preceding claims, characterized in that the RMS roughness of the coating (3) is between 0.2 and 20 nm.

13. The substrate as claimed in one of the preceding claims, characterized in that at least one thin film having an antistatic, thermal or optical function, or forming a barrier to the migration of alkalis coming from the substrate, is deposited beneath said coating.

14. The substrate as claimed in claim 13, characterized in that said thin film having an antistatic function, possibly with controlled polarization, and/or having a thermal and/or optical function is based on a conducting material of the metal type or doped metal oxide type, such as ITO, SnO₂:F, ZnO:In, ZnO:F, ZnO:Al, ZnO:Sn, or a metal oxide substoichiometric in oxygen, such as SnO₂₋ₓ or ZnO₂₋ₓ, where x<2.

15. The substrate as claimed in claim 13, characterized in that said thin film having an optical function is based on an oxide or a mixture of oxides, the refractive index of which is intermediate between that of the coating and that of the substrate, the oxide(s) being especially chosen from the following oxides: Al₂O₃, SnO₂, In₂O₃ and silicon oxycarbide or oxynitride.

16. The substrate as claimed in claim 13, characterized in that said thin film having an alkali metal barrier function is based on silicon oxide, nitride, oxynitride or oxycarbide, Al₂O₃:F or aluminum nitride.

17. The substrate as claimed in claim 13, characterized in that said coating constitutes the final layer of an antireflection multilayer stack.

18. Antisoiling and/or hydrophilic, monolithic, multiple (of the double-glazing type) or laminated glazing incorporating the substrate as claimed in one of the preceding claims.

19. The application of the substrate as claimed in one of claims 1 to 17 to the manufacture of hydrophilic and/or antisoiling, self-cleaning glazing, of the type for removing organic and/or mineral soiling, especially glazing for buildings, of the double-glazing type, vehicle glazing, of the automobile windshield, rear window or side window type, glazing for trains, aircraft and water-borne vehicles or utilitarian glazing, such as glass for aquaria, shop windows, greenhouses or porches, glass for interior furnishings, such as tables, shelves, staircase treads, walls in any position, said glass optionally having surface irregularities, especially being printed, textured, satined, sanded, lacquered or varnished, ophthalmic glass, glazing for urban furniture, mirrors, television, telephone or similar screens, glazing having electronically controlled variable absorption, covers for lamps, of the flat lamp or tunnel lamp type, or any architectural material, of the curtain wall, cladding or roofing type, such as tiles, rendering.

20. A process for obtaining the substrate as claimed in one of claims 1 to 17, characterized in that said coating is deposited by liquid pyrolysis, especially from a solution comprising at least one precursor of said photocatalytic first compound, especially a titanium organometallic precursor of the titanium chelate and/or titanium alcoholate type, and a precursor of said second compound.

21. A process for obtaining the substrate as claimed in one of claims 1 to 17, characterized in that said coating is deposited by a sol-gel technique, with a deposition mode of the dip-coating, cell-coating, spray-coating or laminar flow-coating type, using a solution comprising at least said photocatalytic first compound and said second compound and/or a precursor of said photocatalytic first compound, especially a titanium organometallic precursor of the titanium alcoholate type, and a precursor of said second compound.

22. A process for obtaining the substrate as claimed in one of claims 1 to 17, characterized in that said coating is deposited by chemical vapour deposition (CVD) from at least one precursor of said photocatalytic first compound, especially a titanium precursor of the halogen or organometallic type, and a precursor of said second compound.

23. A process for obtaining the substrate as claimed in one of claims 1 to 17, characterized in that said coating is deposited by a reduced-pressure technique, such as reactive or nonreactive sputtering, especially magnetron sputtering.
